(19) United States
(12) Patent Application Publication
(10) Pub. No.: US 2010/0156694 A1
(43) Pub. Date: Jun. 24, 2010

(54) SYSTEM AND METHOD FOR CREATING MACRO ROUTINES IN A REMOTE CONTROL

(75) Inventors: David J. Rye, Kent, WA (US); James R. Phillips, Bellevue, WA (US); George E. Stevenson, Kowloon (HK)

Correspondence Address: BLACK LOWE & GRAHAM, PLLC, 701 FIFTH AVENUE, SUITE 4800, SEATTLE, WA, 98104, US

(73) Assignee: X-10 LTD., Kowloon (HK)

(21) Appl. No.: 12/343,146

(22) Filed: Dec. 23, 2008

(51) Int. Cl. H04L 17/02

(52) U.S. Cl. 341/176

(57) ABSTRACT

A remote control for appending commands into a learned macro routine of commands is provided. A receiver is arranged to receive signals from one or more remote controls, wherein the signals represent one or more commands comprising a macro. The remote control stores the macro in memory and has “learned” the received macro. The learned macro can be modified by appending one or more additional commands into the macro using commands already contained within the remote control.

### FIELD OF THE INVENTION

This invention relates generally to a remote control and, specifically, to a system and method for creating macro routines in a remote control.

### BACKGROUND OF THE INVENTION

A handheld remote control is typically used to control electronic devices such as televisions, videorecorders, cable or satellite television tuners, stereo receivers, and other components. The handheld remote control sends control signals to the controlled device by irradiating the device with an electromagnetic signal, typically either in the infrared (IR) range or radio frequency (RF). The controlled device receives a pattern of intermittent irradiation or illumination comprising a control signal.

The remote control unit has stored patterns corresponding to push buttons (or a touch screen or other user interface) assigned to various functions of the controlled device. Activating a button causes the remote to transmit a signal corresponding to the stored pattern, thereby generating and transmitting a control signal. Control signals tend to be short words of data representing a low order numeric signal corresponding to some function of the controlled electronic appliance. The controlled device includes a receiver or antenna and circuitry that receives and interprets the signal, which then causes the controlled device to perform a corresponding function such as changing a channel or increasing the volume.

Various manufacturers have selected unique numeric codes to control their devices. This unique coding has allowed differentiation between such devices. For instance, a Brand X recording device will have a limited vocabulary of signals that influence its action. The Brand Y television will have a different limited vocabulary of signals. A cable or satellite set top box may have yet a different vocabulary. If a signal is not present within a device's vocabulary, the device will do nothing. With several devices, each having a distinct and limited vocabulary, a single universal remote control can control all of them, distinctly, so long as the universal remote is configure to use the appropriate set of commands for the device to be controlled.

It is often desirable for the universal remote control to learn macro routines of multiple keystrokes from various remotely controlled devices. For example, a universal remote control can store sequences of commands, such as VCR power followed by VCR play followed by TV power followed by TV audio/video. Such a macro routine would be associated with a macro designation, such as a number. Some, remote controls with macro functionality include a single key, usually designated a macro key, for accessing macro routines. Thus, the user would only need to press a macro key followed by a desired macro routine number to access an entire sequence of stored keystrokes corresponding to several commands for various remotely controlled devices. This reduces the time required for issuing the several commands, and also reduces the probability of an undesired keystroke being pressed, resulting in an undesired command being issued.

Certain methods are currently known for programming macros in remote controls. For example, desired commands may be entered directly on a universal remote control as taught by U.S. Pat. No. 5,414,426. However, entering commands for remotely controlled devices directly on a universal remote control limits the number of commands for the remotely controlled devices to those command signals that are stored in memory on the universal remote control. Existing universal remotes that have macro capability can only store a sequence of commands if the individual commands are present in the code library in the universal remote.

It is also known to enter command codes for remotely controlled devices in a computer. Once all the commands are entered in the computer, the commands are transmitted from the computer to the universal remote control. A computer's knowledge of remotely controlled devices and their function commands is significantly greater than those that can be stored in a universal remote control on which the macro command sequences are entered directly as described above. Also, the computer's library of remotely controlled devices and their function commands can be easily updated, while those stored on a universal remote control cannot. However, entering the macro sequence on a computer and then transmitting it to the universal remote control requires access to a computer and associated software to learn and transmit the macro sequence.

In accordance with yet another method as described in U.S. Pat. No. 6,998,997, a remote control can be programmed with a macro routine by sending a signal from a first remote to a second remote, in which the signal includes one or more commands that form the macro routine. The second remote receives the signal and stores it as a macro routine. Thereafter, the same signal may be transmitted by the second remote, which has “learned” the routine from the first remote, by pressing the corresponding button on the second remote.

### SUMMARY OF THE INVENTION

The present invention provides a system and method for learning and storing on a remote control a macro sequence of commands received from one or more other remote controls, and modifying the received or “learned” macro sequence by appending one or more additional commands.

In one example of the invention, the appended command is appended to the beginning of the learned macro sequence, as in the form of a prefix. One exemplary version of such a command is to append a power on command to the beginning of the macro command.

In other examples of the invention, the appended command is appended to the end of the learned macro sequence, as in the form of a suffix. In this version, the appended command will be received and performed in the controlled device after the operation of the commands from the learned macro sequence.

In accordance with some versions of the invention, the appended command is used to control an operation of a different device than the one or more devices being controlled by the operation of the learned macro. Thus, for example, the appended command may be used to turn on the power for a cable box while the learned macro code may be used to turn on the television, tune it to a particular channel, and set the volume to a preset value.

### BRIEF DESCRIPTION OF THE DRAWINGS

Preferred and alternative examples of the present invention are described in detail below with reference to the following drawings.

FIG. 1 is a representative view of a remote control in operation controlling an electronic device.

FIG. 2 is a representative view of a first remote control learning a macro by receiving a signal from a second remote control.

FIG. 3 is a block diagram of a preferred remote control.

FIG. 4 is a flow chart for a preferred method of learning a macro command.

FIG. 5 is a flow chart for a preferred method of editing a learned macro command.

FIG. 6 is a flow chart for a preferred method of appending a stored command to a learned macro command.

### DETAILED DESCRIPTION OF THE PREFERRED EMBODIMENT

FIG. 1 shows a representative remote control 10. As discussed further below, the remote control 10 is preferably configured for recording and storing a sequence of command signals, referred to as a macro, such that the macro can be used for controlling one or more electronic devices 11 by sending an IR or RF signal 12 from the remote control to the electronic device. The remotely controlled electronic device 11 may include one or more of a variety of devices, such as a television (TV), a video cassette recorder (VCR), a digital video disk (DVD) player, an audio amplifier, a radio receiver, a compact disk (CD) player or recorder, cable or satellite set top box, digital video recorder, personal computer media player, or others.

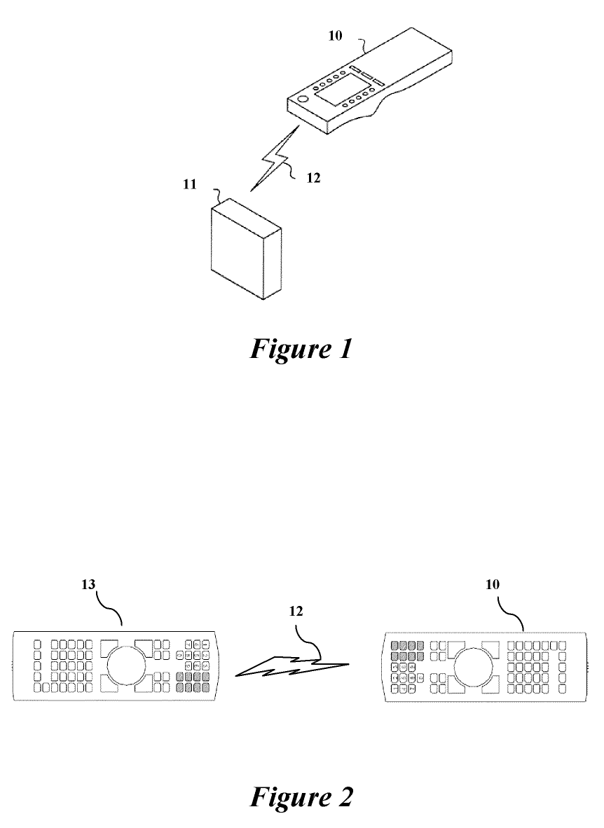

By way of non-limiting example, a macro could include commands such as: turn on the TV, turn on the cable box and set it to channel 63, turn on the VCR, and set the VCR to record the program. The non-limiting example of this macro would involve learning commands from the original equipment remotes for a TV, cable box, and VCR. The macro may be programmed into the remote control 10 directly by using the remote control keypad or other user input. Alternatively, the remote control 10 may “learn” the macro commands by receiving an IR or RF signal 12 from any one of a variety of second remote controls 13 that are associated with one or more electronic devices to be controlled. This learning mode is represented in FIG. 2 in which the first remote 10 receives an IR or RF signal 12 from the second remote 13. The first remote stores the received command signal in memory and associates it a user input (for example, by assigning it to one or more buttons on the remote keypad). Thereafter, the first remote 10 has “learned” the macro command signal and can issue the same command by pressing the assigned key or keys.

Referring now to FIG. 2, an exemplary learning remote control 10 includes a receiver section 16 that includes an infrared (IR) photo detector diode 18 and an amplifier 20. The photo detector diode 18 receives a serial bit control signal 22 from the handheld remote control unit, generally an infrared control signal with a carrier frequency of between 10 and 75 kHz. Of course, any frequency range may be used consistent with this invention. Commercially available IR remote control units use several modulation schemes to encode IR commands to the controlled device. In addition (or in the alternative) the remote may further include an RF receiver to receive and learn RF commands. In such a case, the remote 10 will also include associated amplifiers and demodulators, as appropriate, to process the received commands.

The photo detector diode 18 acts as its own demodulator in any IR communications application. Infrared radiation is that class of electromagnetic radiation with a frequency of between 1012 and 1014 Hz. The photo detector diode 18 will only trigger in the presence of infrared radiation and, when triggered, passes a constant current. Latency of the diode smoothes adjacent sampled highs into a single pulse. Thus, the signal from the photo detector diode 18 amplified by the amplifier 20 to logical levels requires no further demodulation.

The learning remote control 10 includes a processor section 24. The processor section 24 includes a microprocessor 26. The microprocessor 26 is coupled to receive an output signal from the amplifier 20. The processor section 24 also includes a nonvolatile memory device 28. The nonvolatile memory device 28 preferably stores operating system instructions for the micro processor 26, and may be in the form of devices such as read-only memory (ROM), programmable read-only memory (PROM), electrically programmable read-only memory (EPROM), electrically erasable programmable read-only memory (EEPROM), or any other storage media. The processor section 24 also includes a volatile memory device 30, such as random access memory (RAM), for temporarily storing signals that make up macro routines until the macro routines are saved in the nonvolatile memory 28. Macros are temporarily stored in the volatile memory 30 while the macro routines are being set up. When a routine setting up the macro is exited, the macro is saved in non-volatile memory 28. However, in other versions of the invention, macros are permanently saved in the volatile memory 30, thus eliminating the cost of the nonvolatile memory 28. Likewise, the memory for storing the macros and all other stored instructions or data may comprise a single memory, separate storage devices, or any other form.

One or more batteries (not shown) that provide electrical power to the remote control 10, including the volatile memory 30. A capacitor (not shown) can provide backup to the volatile memory 30 while the batteries that power the remote control 10 are being changed. The microprocessor 26 is gated by a clock 32.

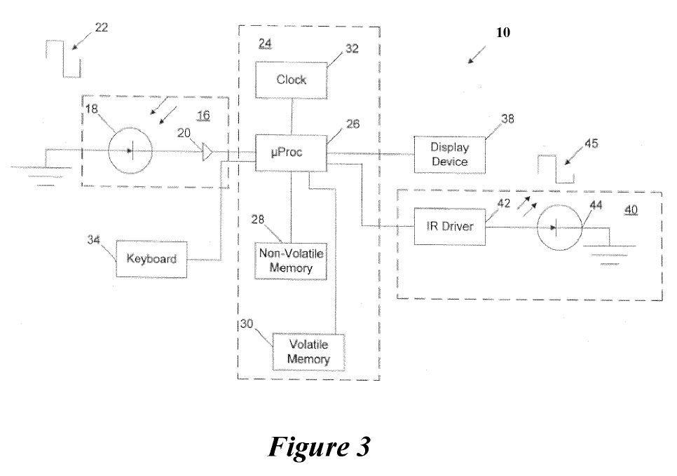

The remote control 10 includes a user input device that is illustrated in FIG. 3 as a keyboard 34. Though illustrated and described in a preferred form as a “keyboard,” it should be appreciated that the user input device may include a touch screen, icons, or any other manner of enabling a user to cause the remote to send a desired signal to a controlled device. The keyboard 34 preferably includes a plurality of keys that correspond to remote control functions, such as channel +, channel −, volume +, volume −, mute, play, stop, fast forward, rewind, and the like. In one version, the keyboard 34 also includes a numeric keypad.

The keyboard 34 optionally includes a setup key. When the setup key is depressed, the processor section 24 causes the learning remote control 10 to enter a mode that sets up selected functions. The keyboard 34 may also include a macro key. When the macro key is depressed, the processor section 24 causes the learning remote control to perform macro functions. For example, after the macro key 36 is depressed, the user depresses one or more of the numeric keys to designate or access a macro routine associated with that macro number designation.

The keyboard 34 may also include a learn key. When the learn key is depressed the processor section 24 causes the learning remote control 10 to enter a mode in which a macro routine is learned. Pressing an exit key causes the processor section 24 to exit its current operating mode, such as the learning mode. Additionally, the exit key may be depressed in response to a prompt to indicate that the prompted selection is being declined.

The keyboard 34 may be provided in various other formats as desired. For example, in one embodiment the keyboard 34 is provided as a “virtual keyboard” displayed on a Liquid Crystal Display (LCD) or “touchscreen.” In another embodiment, the keyboard 34 includes only movable keys or a mix of movable keys and icons or keys on a touchscreen.

The learning remote control optionally includes a display device 38. The display device 38 may be, for example, a liquid crystal display (LCD) or a light emitting diode display (LED) display. The display device 38 receives its input signals from the microprocessor 26 to display any of a variety of indicators such as the number or name of a currently selected macro, the mode of operation, a selected channel, or other information.

An optical transmitter section 40 receives electronic signals from the microprocessor 26, that have been retrieved from the volatile memory device 30, and converts the electronic signals from the microprocessor 26 to optical signals that are transmitted. The optical transmitter section includes an infrared driver 42. The infrared driver 42 outputs an electronic signal to an infrared diode 44. In response to receipt of an electronic signal from the infrared driver 42, the infrared diode 44 transmits an optical signal 45 that is similar in electromagnetic radiation characteristics to the serial bit control signal 22. In one embodiment, the infrared diode 44 is provided as a separate diode from the photo detector diode 18.

If desired, the photo detector diode 18 may be located at an opposite end of the learning remote control 10 from the location of the transmitting infrared diode 44. This arrangement provides for the photo detector diode 18 at an opposite end to a transmitting IR LED on the original equipment remotes 13, thereby permitting the original equipment remote 13 and the learning remote control 10 to point in a common direction. Thus, keys for the original equipment remote controls 13 and the learning remote control 10 are all “right side-up” to the user, instead of keys from one of the remote controls being “upside down” to the user.

In addition to the transmitting infrared diode 44, the remote control 10 may include an RF transmitter configured and coupled to the microprocessor such that the RF transmitter can transmit RF signals to appropriate electronic devices that are configured to receive RF commands rather than IR commands.

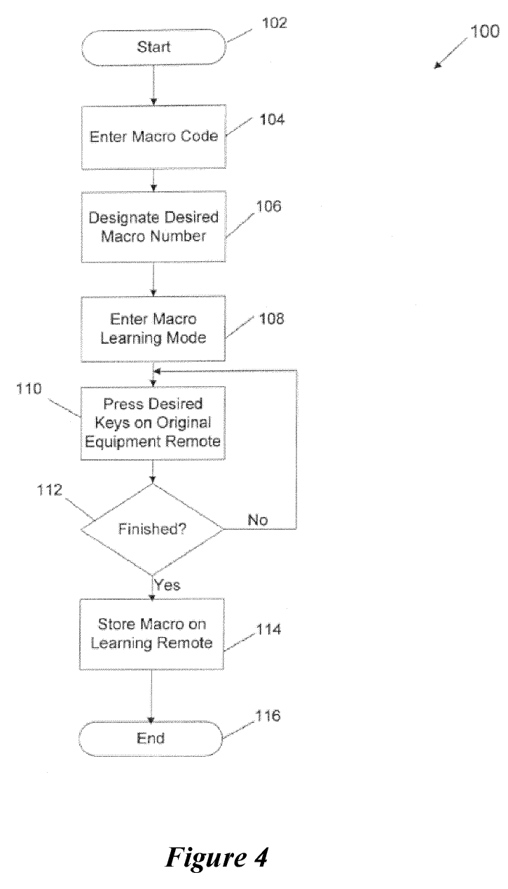

Operation of a preferred method 100 for learning a macro command from a second remote is illustrated in FIG. 4. The method starts at a block 102. At a block 104, a macro mode is entered. In one embodiment, the setup key is depressed and the display screen displays a message that informs the user that a setup mode is entered. For example, a suitable message is “Code Setup . . . Mode?” However, text of any particular message may be chosen as desired in order to communicate to the user that the user is entering a setup mode. In one version, the macro mode is entered directly by pressing the macro key. In another version of the invention, the macro mode is entered by choosing the macro mode from a menu of modes as displayed on the display device 38. A selection of the macro mode from a menu of modes may therefore be performed in any acceptable manner. One further example includes pressing up or down keys on the keyboard 34 until a message identifying the macro mode appears on the display device 38, and then confirming selection of the macro mode by depressing an enter key, an OK key, or the like.

At a block 106, a desired macro routine number (or letter, character, label, or other indicator) is designated. As one example, one of the numeric keypads representing a number from 1-9 is pressed on the keyboard 34. The microprocessor 26 causes a word representing the macro routine number selected on the keyboard 34 to be stored in a buffer. The macro routine number and the macro routine are ultimately stored in the nonvolatile memory 28. As a result, the number of macro routines that can be learned and stored may be varied, as desired, depending upon memory space available to store the learned macro routines. For example, according to one embodiment of the invention, 9 macro routines may be learned and stored in the nonvolatile memory 28. If less memory space in the nonvolatile memory 28 is available, then fewer than 9 macro routines may be stored in the nonvolatile memory 28. Alternatively, it may be desirable to partition the nonvolatile memory 28 for other purposes, leaving available memory space in the nonvolatile memory 28 for fewer than 9 stored macro routines. Alternatively, a larger nonvolatile memory 28 may be used. In this case, more than 9 macro routines may be stored in the nonvolatile memory 28 and, at the block 106, a combination of two or more numeric keypads are pushed to designate the desired macro number.

At a block 108, a macro learning mode is entered. By entering the macro learning mode, the microprocessor 26 becomes prepared to receive command signals transmitted by the original equipment remote control 13 and received by the learning remote control 10 at the photo detector diode 18. In one embodiment of the invention, at the block 108 the display device 38 displays a message that prompts the user to confirm whether it is desired to learn the macro routine number that was designated at the block 106. Confirmation to enter the macro learning mode may be provided by depressing any acceptable key on the keyboard 34. For example, according to one embodiment of the invention, entering the macro learning mode is confirmed by pressing the learn key. Alternatively, it is not necessary to dedicate a specific key on the keyboard 34 as the learn key. According to another embodiment of the invention, any key on the keyboard 34 except the OK key may be pressed to enter the macro learning mode. When the learning mode is entered, the display device 38 displays a suitable message indicating that the learning remote control 14 is in the learning mode.

At a block 110, desired keys, representing desired functions to be performed by the original equipment remotely controlled device, are pressed on the original equipment remote control 13. According to an embodiment of the invention, the original equipment remote control 13 generates and transmits an optical signal, such as the serial bit control signal 22, that is received by the photo detector diode 18 of the learning remote control 10. At the block 110, infrared communications are established between the original equipment remote control and the learning remote control. Infrared communications are suitably established by placing the original equipment remote control 13 and the learning remote control 10 end to end such that the photo detector diode 18 of the learning remote control and the infrared diode 44 of the original equipment remote control that is being learned from are within a line-of-sight at an acceptable distance, such as approximately two inches. In the case of learning RF commands, the line of sight configuration is unnecessary. When the microprocessor 26 receives the signal from the amplifier 20, the microprocessor causes the signal to be stored in the buffer. The microprocessor 26 also causes a counter to begin counting keystrokes. The microprocessor 26 causes the keystroke count to be placed in another buffer (not shown). According to one embodiment of the invention, when the signal is successfully received by the learning remote control 10 and stored in the buffer, the microprocessor 26 causes the display device 38 to display a message informing the user that the signal has been successfully stored. The displayed message regarding successful storage of the signal prompts the user to release the key on the original equipment remote control 13. The microprocessor 26 causes the counter to increment the count of the signal to be stored by one, and the learning remote control 10 is ready to receive the next signal from the original equipment remote control 13.

At a decision block 112, a determination is made whether all of the desired commands have been transmitted from the original equipment remote control to the learning remote control. Depending on available memory space, the number of command signals that may be stored for each macro routine may be limited due to memory constraints. For example, it may be desirable to limit the number of command signals per macro routine to a predetermined number, such as 20. When a determination is made at the decision block 112 that more commands are to be learned for the macro routine, the method returns to the block 110, and more commands are transmitted from the original equipment remote control to the learning remote control.

When a determination is made at the decision block 112 that no more commands are to be transmitted from the original equipment remote control 13 to the learning remote control 10, the method proceeds to block 114 where the macro routine is stored on the learning remote control. The determination that no more commands are to be transmitted from the original equipment remote control may be made by the user. Alternatively, the determination may be made at the decision block 112 that no more commands are to be transmitted by the original equipment remote control when the counter indicates that the predetermined number of commands have been transmitted by the original equipment remote control.

At block 114, the microprocessor 26 causes the display device 38 to display a suitable message that prompts the user to store the desired macro routine. The user pushes a suitable key, such as an OK key or an Enter key on the keyboard 34. The microprocessor 26 then causes the number designation of the macro routine and the signals for the commands of the designated macro routine to be loaded from the buffer into the volatile memory device 30 for storage. Alternatively, when the predetermined number of signals have been received from the original equipment remote control, the microprocessor 26 automatically causes the macro routine designation number and command signals to be loaded from the buffer into the volatile memory 30 for storage. The method ends at a block 116.

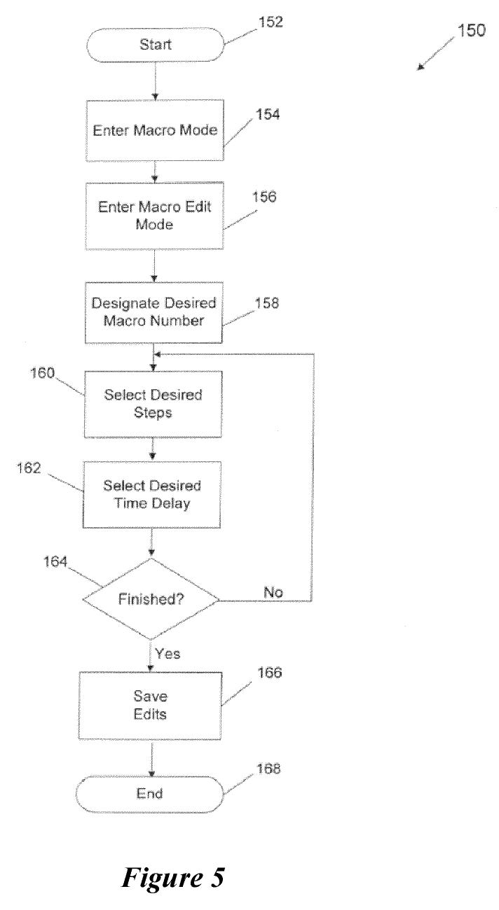

Referring now to FIG. 5, a method 150 is provided for editing a macro routine, including appending the learned macro routine with one or more additional commands. Initially, the method 150 permits delays to be varied between transmissions of individual commands within a macro routine. The response time of different remotely controlled devices varies depending upon device and the function the device is performing. For example, it may take several seconds for a picture tube of a television to warm up in response to a command that turns on the television. However, response time by a remotely controlled device may be approximately instantaneous to other commands, such as commands to adjust volume or channel selection.

The method 150 begins at a block 152. At a block 154, the macro mode is entered as described above for the block 106. At a block 156, a macro edit mode is entered similarly to entering the macro learning mode at the block 110. At a block 158, the desired macro number is designated similarly to designating the desired macro number at the block 108.

At a block 160, desired steps are selected between which a delay is to be edited. The microprocessor 26 causes the display device 38 to display a current and a next step in the macro routine, and the current delay between transmission of optical signals corresponding to the current and the next steps. For example, initially the display device 38 indicates steps 1 and 2 and the delay between steps 1 and 2, such as for example, one second. Any acceptable time delay may be initially inserted between steps of a macro routine. Selection of any initial or default delay between consecutive steps of a macro routine may be made as desired.

At a block 162, a desired time delay is selected. In one embodiment of the invention, a predetermined key on the keyboard, such as the up key, can be pressed to increase delay time. Conversely, delay time may be decreased by pressing a different predetermined key on the keyboard, such as the down key. In response to the up or down keys being depressed, the microprocessor 26 designates an appropriate number of blocks of memory locations in the volatile memory device 30 that are inserted between the selected steps of the macro routine. As the macro routine is accessed for transmission to the remotely controlled device, the commands are caused to page through the blocks of memory location, thus inserting time delays between the commands. In one example, each press of the up key or down key increases or decreases, respectively, by 0.5 seconds the delay between steps of a macro routine. The length of each incremental edit to delay time between steps in a macro routine in response to pressing of the predetermined key may be selected as desired.

It may further be desirable to limit minimum and maximum delay times between consecutive steps of a macro routine. For example, in an embodiment of the invention, minimum delay time between consecutive steps of a macro routine is 0.5 seconds. Similarly, in an embodiment of the invention, maximum delay time between consecutive steps of a macro routine is 9.5 seconds. Selection of a particular minimum or maximum delay time, if any, is determined as desired to conserve memory space and may not be required in all versions of the invention.

At a decision block 164, a determination is made whether or not editing delay times is finished. If a determination is made that editing delay times is not finished, the method returns to the block 160. In one version, the OK key is pressed to return to the block 160. In response to pressing of the OK key, the microprocessor 26 causes the counter to increment by one the current and next macro routine steps between which the delay time is to be edited. When a determination is made at the decision block 164 that editing delay time is finished, the method proceeds to a block 166. In an embodiment of the invention, the user may finish editing macro step delay times whenever desired simply by pressing a predetermined key, such as the exit key 39. Alternatively, after the delay time between the next-to-last and last steps of a macro routine is edited, the method 150 proceeds to the block 166.

At the block 166, edits to delay times are saved. The microprocessor 26 causes the macro routine with edited delay times to be stored in the nonvolatile memory device 28 as described above. The method 150 ends at a block 168.

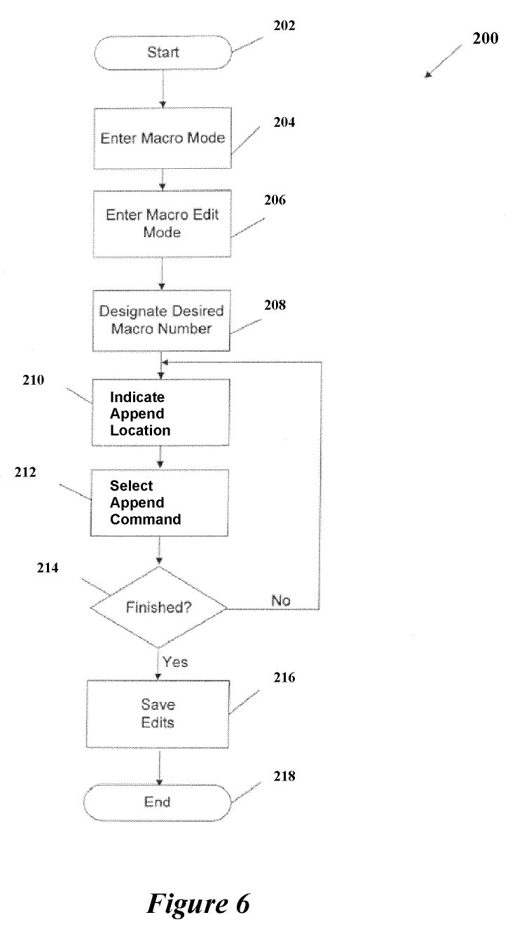

In FIG. 6, a preferred method 200 for editing a learned macro command to append an additional command is shown. In accordance with a preferred version, a command stored in the learning remote 10 is appended to the macro command that is learned from the original equipment or other remote 13. As one example, as described below, a stored power on command for controlling a cable or satellite receiver is appended to a learned macro command directing a TV to turn on and tune to a particular channel.

The method begins at a block 202, and enters a macro mode at a block 204. Entry of the macro mode may be by any suitable means, including the same means as described above with reference to FIG. 5. At a block 208, the desired macro number (or label or other indicator representing the chosen learned macro) is designated similarly to designating the desired macro number at the block 108. Once the macro is learned and appended as desired, it may be initiated by selecting the chosen macro from among a listing of macros. Alternatively, any key may be assigned to the learned and appended macro, including a power key. In a preferred version, when a key already having a particular dedicated function (such as the power key) is chosen as the macro triggering key, the function of that key is also appended to the macro. Thus, for example, selecting the cable or set top box power key as the key to cause operation of the macro can be useful where the cable or set top box power on/off is the appended command.

At a next block 210, the user is prompted to indicate the location at which the appended command is to be inserted. As one example, and additional appended command can be inserted at the beginning of a learned macro command, serving as a prefix to the learned command. Alternatively, the additional appended command may be appended to the end of the learned command, serving as a suffix. As yet another alternative, the appended command can be inserted between any of the commands within the macro. Rather than the mere insertion of a delay, however, an additional command, such as turning power to a device on or off or changing the channel, is appended.

The method then proceeds to a next block 212 in which the user is prompted to select the command that is desired to be appended at the chosen location. The selection process may occur in a variety of ways, consistent with the invention. In one example, the user selects the command to append by pressing one or more corresponding keys on the learning or universal remote control 10. If the command is to power on a cable box, the user would press the power button on the remote control 10, thereby causing the power on command to be appended at the chosen location. In another example, the display may present a plurality of command options, either in the form of codes, icons, or words representing the possible commands. The user then may, for example, scroll up or down using arrow keys, then pressing an Enter key to indicate a selected command to append.

After selecting a command, the microprocessor causes the internal stored programming instructions within the memory to insert the selected appended instruction into the appropriate chosen location within the learned macro. The stored macro may be, for example, in the form of a table containing the commands or indicators corresponding to the listing of commands. The appended command may be inserted into the table in the appropriate location, thereby modifying the listing of stored commands or indicators with the addition of the appended command.

Although steps 210 and 212 indicate a method in which the append location is chosen and then the append command is selected and inserted, those two steps may be performed in the opposite order. Thus, the user may first be prompted to select the command to append and then, after the selection, the user may be prompted to indicate the location. In yet other versions of the invention, the method may by default append the additional command either to the beginning or the end of the learned macro.

At a block 214, the user is asked whether there are any additional commands to append. This step is an optional step, and in alternate versions of the invention only one command may be appended and the user is not queried as to whether there are additional commands to add. In the event the user indicates the desire to append another command, the method returns to block 210 and the process continues as described above.

If there are no further commands to append, the process continues to block 216 at which point the modified macro is saved in the appropriate portion of the remote control memory. Thereafter, the method ends, indicated by block 218.

In the method and system as described above, any of a variety of commands may be appended to a macro learned from another remote. In a preferred version, the above method allows a command from a first remote to be appended to a macro learned from a second remote. This can be particularly useful in situations where the second remote is not capable of performing all of the commands desired to be included in the macro, but where the first remote does include one or more of the missing commands. In such a case, the first remote can append the additional command to the learned macro, thereby completing the macro and making it more functional.

The above system and method can be especially useful, for example, when the learned macro includes a series of commands for a first electronic device and the desired additional command is for a second electronic device. For example, the learned macro may turn on the TV, set its channel, and set a volume level. The learned macro may not include a command to turn on the set top box, and that command can be appended as described above. In this fashion, the macro can be modified to control different electronic devices and can include commands not included in the remote control that created the initial macro. Still further, the above system and method allows for the introduction of RF commands into a learned macro containing IR commands (and, the opposite, the insertion of IR commands into a learned macro containing RF commands).

In one version of the invention, any key in the learning remote control 10 may be assigned to operate the learned macro as appended with the one or more additional functions. The key used to initiate the macro preferably will operate the macro only in a particular chosen mode of operation, as selected by a remote control mode key. Thus, for example, the learning remote control 10 may include a power key that is assigned to a set top box, either in a fixed fashion or as a universal power key that powers on or off the set top box when a user selects the set top box from a mode key. This power key (or any other key as desired) may be used to initiate the learned macro as appended to the command to power on the set top box.

In one version, the learned macro may include commands to turn on a television. The learned macro may comprise a single command to turn on a television, or may comprise a television power on command accompanied by one or more additional commands (such as setting the channel to a particular number or setting volume to a particular level). The learned TV power on command received from a second remote is appended to the set top box power on command (either before or after the set top box power command, as discussed above), and assigned to be initiated by pressing the set top box power on key. Accordingly, pressing the power on key in the set top box mode (or other assigned macro mode) will power on the set top box and also power on the television (in addition to transmitting any other commands contained in the learned macro).

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A remote control comprising:
a receiver arranged to receive signals from an original equipment remote control the received signals comprising a learned macro having one or more commands;
a microprocessor electrically coupled to receive the signals from the receiver;
an operator interface in communication with the microprocessor; and
a memory containing stored programming instructions operable by the microprocessor to:
store in the memory the learned macro received from the original equipment remote control;
cause the remote control to enter a macro edit mode, the macro edit mode enabling the learned macro to be modified; and
modify the learned macro by appending an additional command, the additional command comprising a command previously stored in the remote control.

2. The remote control of claim 1, wherein the stored programming instructions further cause the microprocessor to store the modified macro in the memory.

3. The remote control of claim 2, wherein the modified macro comprises the additional command appended to the beginning of the learned macro.

4. The remote control of claim 2, wherein the modified macro comprises the additional command appended to the end of the learned macro.

5. The remote control of claim 2, wherein the modified macro comprises the additional command appended to an intermediate location within the learned macro.

6. The remote control of claim 2, wherein the additional command is configured to control a device not controlled by the learned macro.

7. The remote control of claim 2, wherein the additional command is not contained in the original equipment remote control.

8. The remote control of claim 2, wherein stored programming instructions cause the microprocessor to modify the learned macro by capturing one or more inputs entered by the operator interface, the one or more inputs corresponding to commands to control an electronic device.

9. The remote control of claim 8, wherein the operator interface comprises a keyboard.

10. The remote control of claim 2, wherein the learned macro comprises a command to power on or off a first electronic device and the additional command comprises a command to power on or off a second electronic device.

11. The remote control of claim 10, wherein the stored programming instructions further cause the modified macro to be assigned to a key from the user interface.

12. The remote control of claim 11, wherein the key comprises a key assigned to power on or off the second electronic device.

13. The remote control of claim 12, wherein the second electronic device is a cable box or set top box and the first electronic device is a television.

14. A remote control comprising:
a receiver arranged to receive signals from a second remote control the received signals comprising a learned macro having one or more commands;
a microprocessor electrically coupled to receive the signals from the receiver;
an operator interface in communication with the microprocessor; and
a memory containing stored programming instructions operable by the microprocessor to:
store in the memory the learned macro received from the second remote control, the learned macro comprising a first command to power on a first electronic device;
cause the remote control to enter a macro edit mode, the macro edit mode enabling the learned macro to be modified; and
modify the learned macro by appending a second command, the second command being previously stored in the remote control and comprising a command to power on a second electronic device.

15. The remote control of claim 14, wherein the stored programming instructions further cause the modified macro to be assigned to a key from remote control, whereby pressing the assigned key causes the remote to transmit the first command and the second command.

16. The remote control of claim 15, wherein the key comprises a key assigned to initiate the second command.

17. The remote control of claim 15, wherein the second electronic device is a cable box or set top box and the first electronic device is a television.
